(19) United States
(12) Patent Application Publication
(10) Pub. No.: US 2025/0246947 A1
(43) Pub. Date: Jul. 31, 2025

(54) Converter of Static Magnetic Energy into Dynamic Mechanical Energy

(71) Applicant: Elberto Berdut-Teruel, San Juan, PR (US)

(72) Inventor: Elberto Berdut-Teruel, San Juan, PR (US)

(21) Appl. No.: 18/423,737

(22) Filed: Jan. 26, 2024

(51) Int. Cl. H02K 1/04; H02K 7/02; H02K 21/16

(52) U.S. Cl. CPC H02K 1/04; H02K 7/02; H02K 21/16

(57) ABSTRACT

A unit described is capable of converting static magnetic energy into dynamic mechanical motion in a machine. Utilizing a novel composite lightweight coiled winding and phenolic structural materials, non-ferrous and ferrous metals of similar magnetic mass, creates a lightweight and highly efficient magnetic energy converter.

### PATENTS CITED

The following documents and references are incorporated by reference in their entirety, Liu Jinfeng CN105946594A, Berdut-Teruel (U.S. Pat. Nos. 5,615,618 and 8,018,116) and Baca et al (U.S. Pat. No. 7,868,476).

### FIELD OF THE INVENTION

The invention relates to a machine that converts static magnetic energy into dynamic mechanical energy via rotational motion, and specifically to a converter of said static magnetic energy into dynamic mechanical energy via phenolic and ferromagnetic materials in magnetic balance and motion.

### DESCRIPTION OF THE RELATED ART

Electrical-based mechanical motion is traditionally generated from motors that turn a shaft connected to a rotor, utilizing electrically generated magnetic fields to attract permanent magnets or electro-magnets. Traditional motors have windings comprised of conductive wires, but are primarily comprised of ferrous metals. The core for these windings has been traditionally made of iron.

The use of ferromagnetic metal components in the motors results in inherent parasitic losses of magnetic energy efficiency, which result in significant energy being internally consumed to fight these parasitic magnetic forces created within all the ferrous materials when the motor is standing. These have been historically accepted penalties, but newer market requirements and applications, combined with the constant desire to improve efficiencies, have resulted in the need for alternatives.

What is needed, is a machine that eliminates all these parasite losses and converts the inherent potential magnetic energy in magnets into dynamic rotational mechanical energy through the use of phenolic windings that are in electro-magnetic balance with permanent magnetic forces. In such a fashion, a minimal amount of electric energy is required to maintain machine rotation.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a static magnetic energy to dynamic mechanical motion converter machine comprising: a central rotor structure primarily comprised of phenolic materials having a left side and a right side, an equal plurality of magnetic field generating components located on each said side of said rotor, each said magnetic field generating component being located at an offset radial distance equal to 360 divided by the number of magnetic field generating components on one said side of said rotor, wherein the location of the magnetic field generating components on said rotor's right side is offset by half of said radial distance to their location on said rotor's left side, a stator structure surrounding said central rotor structure, said stator structure primarily comprised of phenolic materials and having a left side and a right side, an amount of coils equal to the amount of magnetic field generating components per side, each said coil located on each said side of said stator being located at the same offset radial distance as said magnetic field generating components, wherein the location of the coils on said stator's right side is the same as that of the coils on rotor's left side, wherein each said coil has an T-shaped iron core insert surrounded by a non-ferrous coil winding, a shaft connected to said rotor, a flywheel connected to said shaft, a set of electrical wiring to each said stator's side coil winding and shaft position control components and electrical control elements that regulate the timing of the energy delivered to said electrical wirings. In another aspect said magnetic field generating components are N-pol or S-pol permanent magnets and said winding wire is comprised of all or part of: copper, aluminum or a mixture of either.

In one aspect the invention is about a method of operating a static magnetic energy to dynamic mechanical motion converter machine comprising providing a central rotor structure primarily comprised of phenolic materials having a left side and a right side, providing an equal plurality of magnetic field generating components located on each said side of said rotor, each said magnetic field generating component being located at an offset radial distance equal to 360 divided by the number of magnetic field generating components on one said side of said rotor, wherein the location of the magnetic field generating components on said rotor's right side is offset by half of said radial distance to their location on said rotor's left side, providing a stator structure surrounding said central rotor structure, said stator structure primarily comprised of phenolic materials and having a left side and a right side, providing an amount of coils equal to the amount of magnetic field generating components per side, each said coil located on each said side of said stator being located at the same offset radial distance as said magnetic field generating components, wherein the location of the coils on said stator's right side is the same as that of the coils on rotor's left side, wherein each said coil has an T-shaped iron core insert surrounded by a non-ferrous coil winding, providing a shaft connected to said rotor, providing a flywheel connected to said shaft, providing a set of electrical wiring to each said stator's side coil winding and providing a shaft position control components and electrical control elements that regulate the timing of the energy delivered to said electrical wirings. In another aspect said magnetic field generating components are N-pol or S-pol permanent magnets and said winding wire is comprised of all or part of: copper, aluminum or a mixture of either.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 illustrates a side view of a proposed converter of static magnetic energy into dynamic mechanical motion, according to an exemplary embodiments of the invention.

FIG. 2 illustrates a front view of a proposed converter of static magnetic energy into dynamic mechanical motion, according to an exemplary embodiments of the invention.

FIGS. 3-4 illustrates cross sections of the placement of the proposed composite block windings, according to exemplary embodiments of the invention.

FIGS. 5-8 illustrate cross sections of the proposed windings, according to exemplary embodiments of the invention.

FIG. 9 illustrates a proposed electrical connection of the windings, according to an exemplary embodiment of the invention.

FIGS. 10-13 illustrate views of a nut and rotation platter, according to exemplary embodiments of the invention.

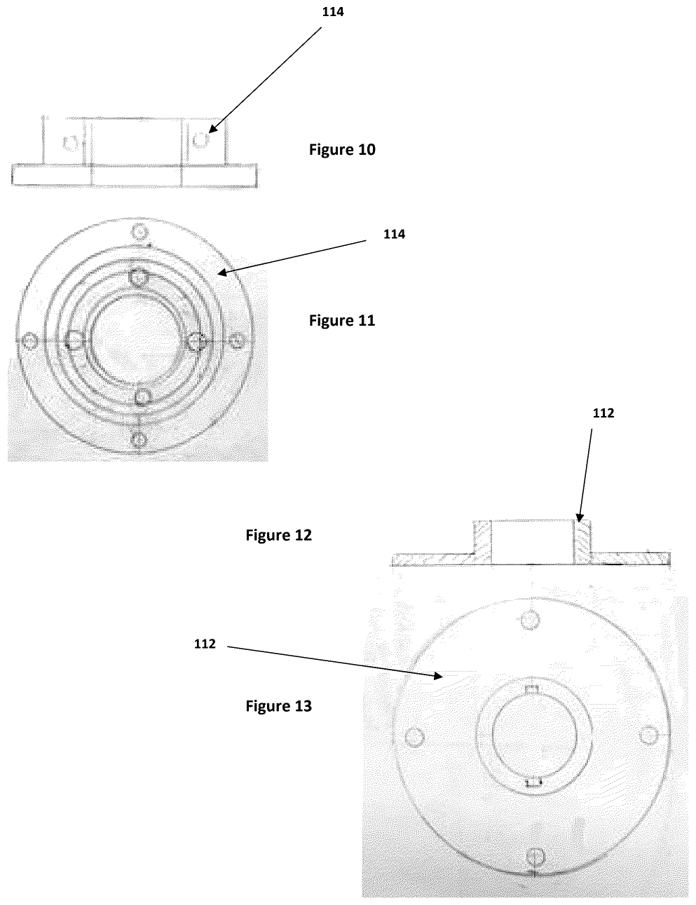

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

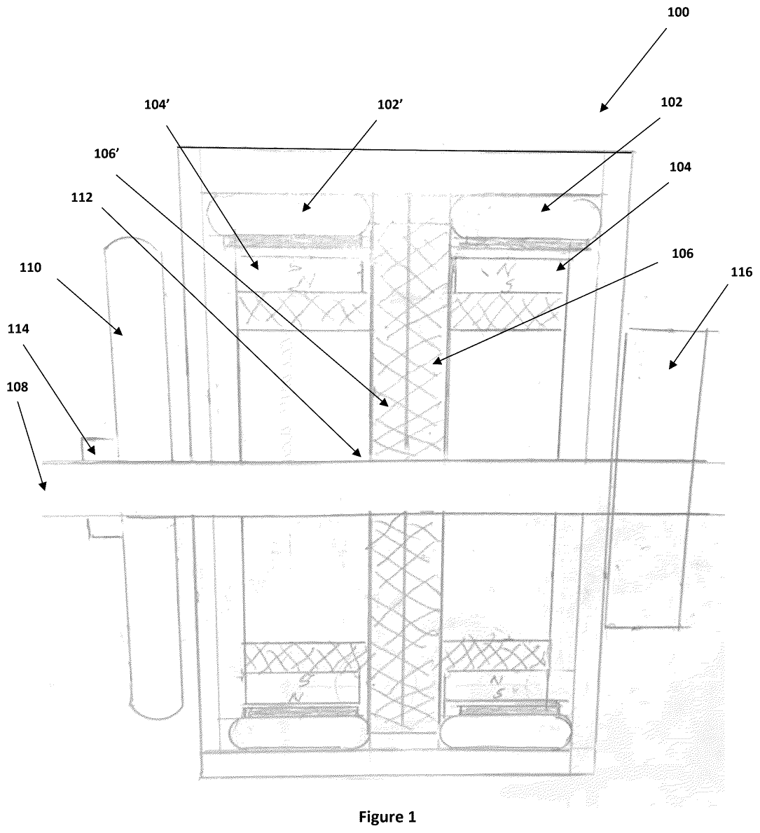

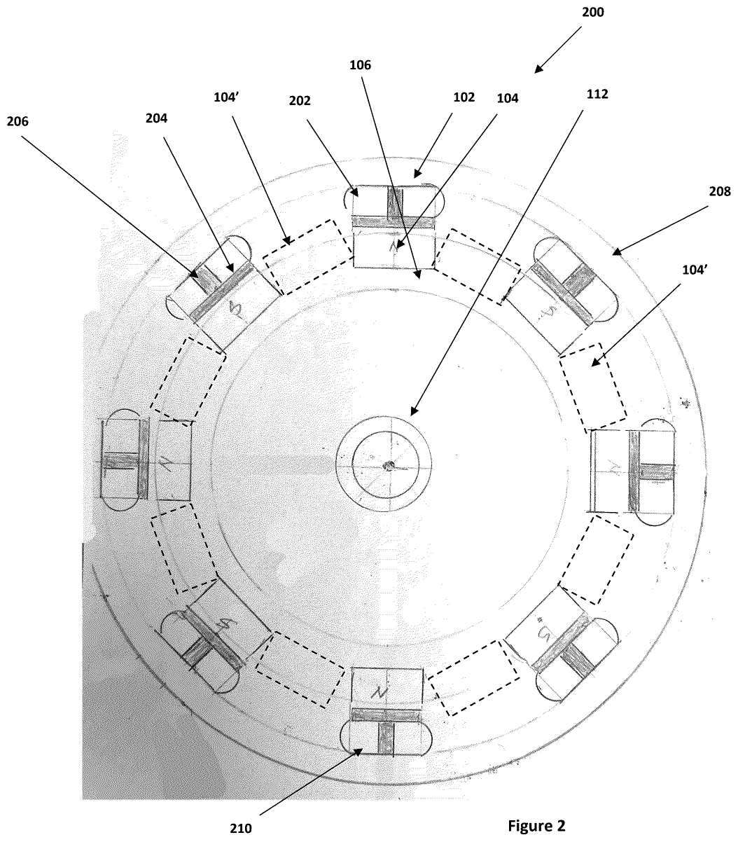

Referring to FIGS. 1-2, we see in one embodiment a coaxial coil and permanent magnet rotary machine configuration 100 for a magnetic energy converter designed to take advantage of the traditional magnetic attraction to ferrous materials. We note that in other embodiments, the machine may be a linear converter or even a reciprocal configuration. In one embodiment, a stator 208 houses an even number of coil windings 202 on each side of said stator 208, the windings being placed at an offset radial distance X from each other. The offset radial distance X is equal to the circumference (360 degrees) divided by the total number of coils/magnets on a side. An equal number of magnets 104 is placed on each side of said rotor, at the same offset radial distance X, with the difference being that the right 106 and left 106′ sides of the rotor's magnets 104/104′ are offset radial distance X/2 (one half of offset radial distance X) from each other.

So in one example, when four pairs of coils 102 (eight coil 102 per side (FIG. 2)) are used on each side, they will be offset at a distance X of 45 degrees, at the same position on each side of the stator 208. Similarly, the magnets 104/104′ on both sides of the rotor 106/106′ will also X degrees from each other (on the same side), that is 45 degrees. However, those on the right side 106 of the rotor will be offset a distance X/2 (22.5 degrees in FIG. 2) from those on the left side 106′ of the rotor.

An equal number of permanent magnets 104 are placed in a rotor 106 rotating within the stator 208, said magnets 104 being similarly spaced along the perimeter of the rotor 106. The rotor magnets 104 are all of a similar polarity (N-pol or S-pol). Shown are permanent magnets, although electromagnets may also be used. Similarly, the coils 102 may be in the rotor, and the magnets in the stator (it's just that this complicates wiring).

In one embodiment, there is a second set of coils 102′ which are placed at the same locations as those for the first side of the rotor 106, but on the second side of the same rotor 106′. However, the magnets 104′ on that side are offset so that when the magnets 104 of one side align with the centers of the coils 102, the other side 106′ magnets are half-way between coils 102/102′. Note that while the above is shown in an embodiment where a stator has two sets of coils and two sets of magnets within the same armature (100/200), the same could be accomplished if there was only one rotor per stator, but they could be two armatures 100/200 connected to the same shaft 108 so that the shown offset positions would be preserved. The reason for this desired alignment will be explained below.

The coils 102 are each comprised of a non-ferrous winding 202 (copper, aluminum, or a mix thereof) wound around a central ferrous core 204 (iron or other similar metal). This iron core 204 is large, so that the attraction from to the magnet 104 is significant. The balance of the structure (rotor, stature, armature), particularly in the areas around the magnets and the coils (outside the core 204) is comprised of primarily of phenolic materials, particularly on the portions close to the stator and rotor upper portions. In one embodiment, the rotor 106/106′ is connected to a rotating axis shaft 108. To smooth operation of the assembly 100, a flywheel 110 (or camshaft) may be used to stabilize transitions in operation. The axle 108 rotates around a ball bearing assembly 114 and the rotor 106 is attached to said axle 108 via an attachment plate 112. Shaft 108 position control components and electrical control elements 116 that provide shaft information to determine/regulate the shaft rotation are shown.

If only one magnetic rotor 106 is present (without the second face 106′ and the second set of magnets 104′) the permanent magnets 104 will be attracted to the iron cores 204, resulting in the ‘lock’ of the system and requiring significant additional energy to start rotation. With the ‘offset’ second face 106′ and magnets 104′, the system is in balance at all times when either set of magnets 104 or 104′ centers on the iron core 204 of the of one side. At any other point, the attraction from either rotor permanent magnet 104/104′ will rotate the rotor until balance is re-established.

It is that magnetic potential energy balance which we exploit through the use of small amounts of electrical energy. As is well understood by those skilled in the art, the magnetic polarity of a coil is created by the direction in which the current within it flows, and the strength of that magnetic field will be based on the amount of current flowing through the wire. By varying either the amount of current through the coil, or the amount of wire within that coil, we can match and neutralize the magnetic attraction of the magnet 104 to the iron core 204 within the coil 202 on one side 106 of the rotor, which will then cause the magnetic attraction of the magnet 104′ on the other side 106′ of the rotor to attract it to the next position, thereby continuing the rotation of the rotor assembly.

We note that the neutralization of the iron core 204 is a first order. And that in another embodiment, the energy applied to the coil 102 may be enough to actually repel the magnet 106 just passing below the iron core 204. Such a repelling force may be optional.

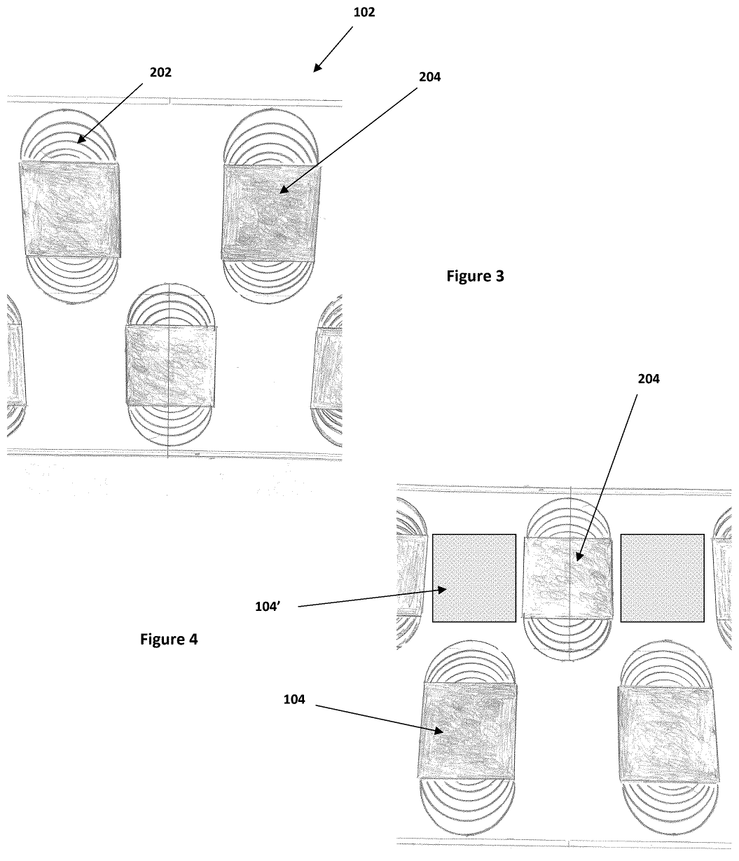

The above is the key to the system (FIGS. 3-4), is that as the magnet reaches the coil 102 (attracted to it by the magnet's 104/104′ attraction to the iron core 204, the coil 102 is energized with enough combined magnetic energy so that the magnetic attraction 106 to the iron core 204 is neutralized. In this fashion, the motion is half generated by the magnet 104 attraction to the iron core 204 of the coil 102 on one side 106 of the rotor, and the other half by the magnet 104′ attraction to the iron core 204 of the coil 102′ corresponding to the other side 106′ of the rotor.

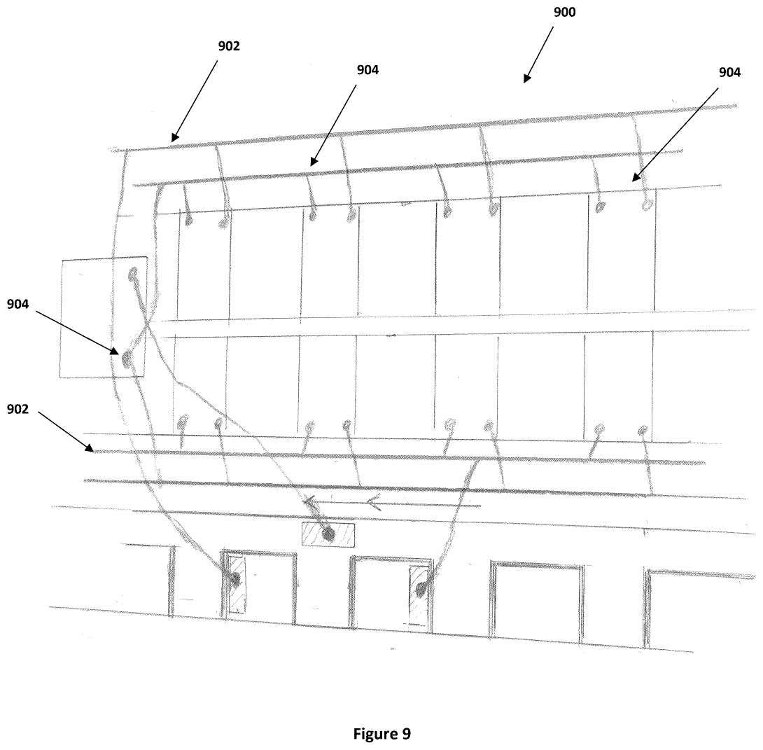

FIG. 9 illustrates one proposed embodiment of the wiring 900 of the coils 102, which allows for the currents that provide the iron core 204 magnetic attraction neutralization on each of the coils 102/102′. In this fashion, the circuit 902 cancels the magnetic attraction to the magnets 104 on one rotor's side 106, and those that are generated 904 cancel that for the magnets 104′ on the other rotor's side 106′.

The disconnection from one circuit 902 to the other 904 may be accomplished by simple brushes, or via an electronic switching system based on the shaft 108 position, as well as on the speed and load on the system 100. We note that the circuit of the coil 202 not being used to neutralize the respective iron cores 204, is left open, thus minimizing/eliminating the current on that coil, and hence the magnetic induced field.

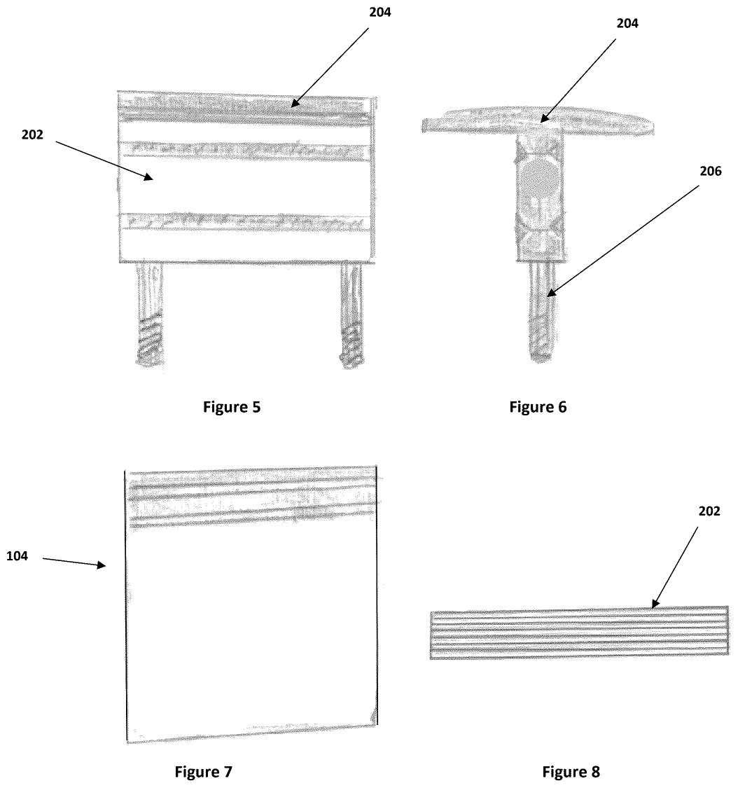

There a number of key design elements (FIGS. 5-8) that allow for the balance of attraction neutralization to be so efficient. A first is the manufacture of the coils 102, where the windings are covered in a phenolic material or other possible preferably non-ferrous metals (again, copper, stainless steel, aluminum, lead), non-ferrous polymers (including amorphous as well as semi-crystalline plastics), ceramics, wood, fiberglass, carbon fiber composites, epoxy composites and others. Not only are the coil 102 casings made of phenolic material, but so are the major components of the stator 208, reducing all other parasitic magnetic effects.

Some of the trade names for the above materials include PromoSpire, Torlon, AvaSpire, Amodel and their competitors. Some of these phenolic materials are a usually thermosetting resins or plastics made by condensation of a phenol with an aldehyde and used especially for molding and insulating and in coatings and adhesives.

The ferrous portion 204, is not only a plug, but shaped to act as a magnetic lens to the magnetic field coming from the permanent magnet 104. One such shape is a ‘dome’ (FIG. 6), which is inverse to that of the stator 208, so that it may face a flat permanent magnet top (FIG. 5), but in a complementary shape to that of the rotor 106.

Finally, the moment when the currents go from being retrieved 902 to being induced 904, presents a ‘shocking moment’, where the system could stammer. As was done with steam engines, we propose to resolve this ‘shock’ by adding a flywheel 110, which will impose its dynamic energy and keep the system rotating. A similar arrangement could be accomplished with a crankshaft having weights opposite of that ‘frozen’ position.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

1. A converter of static magnetic energy into dynamic mechanical energy having composite non-ferrous coil windings, said converter comprising:
a central rotor structure comprised of phenolic and non-phenolic materials having an N number of permanent magnets placed along the outer circumference of said central rotor at equidistant distances;
a stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
a shaft connected to said central rotor and coupled to external mechanical rotation components, including shaft mechanical/electronic components to determine said shaft rotational position;
a flywheel connected to said shaft;
a set of electrical wirings connected to each said stator's composite non-ferrous coil windings; and
shaft position control components and electrical control elements that regulate the timing of the energy delivered to said electrical wirings so that electrical control circuits can deliver current to each said composite non-ferrous coil windings in the appropriate direction and amount, so that based on the shaft position a magnetic field is created around said composite non-ferrous coil winding that cancels the attraction of the permanent magnet to the central ferrous core portion that just passed, allowing it to be ‘pulled’ towards the next central ferrous core.

2. The converter of claim 1 wherein:
said composite non-ferrous coil windings wire is comprised of all or part of:
copper or aluminum.

3. (canceled)

4. (canceled)

5. A method to generate torque on a shaft using a converter of static magnetic energy into dynamic mechanical energy having composite non-ferrous coil windings, said method comprising:
providing a central rotor structure comprised of phenolic and non-phenolic materials having an N number of permanent magnets placed along the outer circumference of said central rotor at equidistant distances;
providing a stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
a shaft connected to said central rotor and coupled to external mechanical rotation components, including shaft mechanical/electronic components to determine said shaft rotational position;
providing a flywheel connected to said shaft;
providing a set of electrical wirings connected to each said stator's composite non-ferrous coil windings;
providing shaft position control components and electrical control elements that regulate the timing of the energy delivered to said electrical wirings so that electrical control circuits can deliver current to each said composite non-ferrous coil windings in the appropriate direction and amount, so that based on the shaft position a magnetic field is created around said composite non-ferrous coil winding that cancels the attraction of the permanent magnet to the central ferrous core portion that just passed, allowing it to be ‘pulled’ towards the next central ferrous core; and
operating said external mechanical rotation component.

6. The method of claim 5 wherein:
said composite non-ferrous coil windings wire is comprised of all or part of:
copper or aluminum.

7. The converter of claim 1 further comprising:
a second rotor structure comprised of phenolic and non-phenolic materials having an N number of permanent magnets placed along the outer circumference of said central rotor at equidistant distances;
a second stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
wherein said second rotor is coupled to said original rotor through a mechanical connection to said shaft, said second stator composite non-ferrous coil windings are placed alongside the original composite non-ferrous windings, and the second rotor permanent magnets are positioned halfway between those of the original rotor;
a set of electrical wirings connected to each said second stator's composite non-ferrous coil windings; and
shaft position control components and electrical control elements that regulate the timing of the energy delivered to said second stator electrical wirings so that electrical control circuits can deliver current to each said second stator's composite non-ferrous coil windings in the appropriate direction and amount, so that based on the shaft position a magnetic field is created around said second stator's composite non-ferrous coil winding that cancels the attraction of the permanent magnet to the central ferrous core portion that just passed, allowing it to be ‘pulled’ towards the next central ferrous core.

8. The converter of claim 2 further comprising:
a second rotor structure comprised of phenolic and non-phenolic materials having an N number of permanent magnets placed along the outer circumference of said central rotor at equidistant distances;
a second stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
wherein said second rotor is coupled to said original rotor through a mechanical connection to said shaft, said second stator composite non-ferrous coil windings are placed alongside the original composite non-ferrous windings, and the second rotor permanent magnets are positioned halfway between those of the original rotor;
a set of electrical wirings connected to each said second stator's composite non-ferrous coil windings; and
shaft position control components and electrical control elements that regulate the timing of the energy delivered to said second stator electrical wirings so that electrical control circuits can deliver current to each said second stator's composite non-ferrous coil windings in the appropriate direction and amount, so that based on the shaft position a magnetic field is created around said second stator's composite non-ferrous coil winding that cancels the attraction of the permanent magnet to the central ferrous core portion that just passed, allowing it to be ‘pulled’ towards the next central ferrous core.

9. The method of claim 5 further comprising:
providing a second rotor structure comprised of phenolic and non-phenolic materials having an N number of permanent magnets placed along the outer circumference of said central rotor at equidistant distances;
providing a second stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
wherein said second rotor is coupled to said original rotor through a mechanical connection to said shaft, said second stator composite non-ferrous coil windings are placed alongside the original composite non-ferrous windings, and the second rotor permanent magnets are positioned halfway between those of the original rotor;
providing a set of electrical wirings connected to each said second stator's composite non-ferrous coil windings; and
providing shaft position control components and electrical control elements that regulate the timing of the energy delivered to said second stator electrical wirings so that electrical control circuits can deliver current to each said second stator's composite non-ferrous coil windings in the appropriate direction and amount, so that based on the shaft position a magnetic field is created around said second stator's composite non-ferrous coil winding that cancels the attraction of the permanent magnet to the central ferrous core portion that just passed, allowing it to be ‘pulled’ towards the next central ferrous core.

10. The method of claim 6 further comprising:
providing a second rotor structure comprised of phenolic and non-phenolic materials having an N number of permanent magnets placed along the outer circumference of said central rotor at equidistant distances;
providing a second stator structure surrounding said central rotor structure, said stator structure comprised of phenolic and non-phenolic materials, wherein said stator structure has an N number of composite non-ferrous coil windings surrounding a central ferrous core, said composite non-ferrous coil windings placed at equidistant distances along the interior of said stator;
wherein said second rotor is coupled to said original rotor through a mechanical connection to said shaft, said second stator composite non-ferrous coil windings are placed alongside the original composite non-ferrous windings, and the second rotor permanent magnets are positioned halfway between those of the original rotor;
providing a set of electrical wirings connected to each said second stator's composite non-ferrous coil windings; and
providing shaft position control components and electrical control elements that regulate the timing of the energy delivered to said second stator electrical wirings so that electrical control circuits can deliver current to each said second stator's composite non-ferrous coil windings in the appropriate direction and amount, so that based on the shaft position a magnetic field is created around said second stator's composite non-ferrous coil winding that cancels the attraction of the permanent magnet to the central ferrous core portion that just passed, allowing it to be ‘pulled’ towards the next central ferrous core.
